(19) United States
(12) Patent Application Publication
(10) Pub. No.: US 2026/0287524 A1
(43) Pub. Date: Sep. 24, 2026

(54) MEASUREMENT HEAD AND GAUGE FOR IMPROVED MEASUREMENT STABILITY

(71) Applicant: Thermo Fisher Scientific Messtechnik GmbH, Erlangen (DE)

(72) Inventors: Alexander Britting, Weißenohe (DE); Florian Woelfel, Ebermannstadt (DE)

(21) Appl. No.: 19/576,155

(22) Filed: Mar. 24, 2026

Related U.S. Application Data
(60) Provisional application No. 63/776,502, filed on Mar. 24, 2025.

(51) Int. Cl. G01N 23/083; G01B 15/02; G01T 7/00

(52) U.S. Cl. CPC G01N 23/083; G01B 15/025; G01T 7/005; G01N 2223/052; G01N 2223/076; G01N 2223/1013; G01N 2223/1016; G01N 2223/102; G01N 2223/633

(57) ABSTRACT

A first aspect of the invention provides a measurement head comprising a radiation source, configured to emit a first radiation beam and a second radiation beam; a segmented chamber; a first radiation detector positioned in a first segment of the segmented chamber and configured to generate a first voltage signal responsive to the first radiation beam; and a second radiation detector positioned in a second segment of the segmented chamber and configured to generate a second voltage signal responsive to material specific radiation produced from an interaction with the second radiation beam.

### TECHNICAL FIELD

This disclosure is in the field of gauges for measuring material thickness and, more particularly, is directed to an apparatus and method for compensating variation such as noise and drift in a gauge.

### BACKGROUND

Thickness gauges can be used in a variety of industrial applications, such as for example, high precision measurement of material and/or coating thickness.

U.S. Pat. No. 2,647,214 discloses an apparatus for examining materials by an X-ray absorption method. In particular, the invention has applicability to the measurement of the thickness of a steel strip as it passes through a rolling mill. The apparatus comprises a source of X-rays such as an X-ray tube. X-rays from the X-ray tube are projected toward a pair of metal strips. A pair of ionisation chambers is provided, corresponding to each metal strip and position on the opposite side thereof from the X-ray tube. As X-rays from the X-ray tube pass through the strips, some of the X-rays are absorbed in accordance with the thickness of the strip. Those X-rays which are not absorbed are received by the corresponding ionisation chamber and produce ions therein so that the ion current is a measure of the thickness of the strip through which the corresponding X-rays pass.

U.S. Pat. No. 3,848,125 discloses a gauge for measuring the thickness of a coating on a metal substrate. The gauge comprises a continuous beam X-ray point source comprising an X-ray tube. The beam derived from the source irradiates the material being monitored. In response to the energy in the beam, the material fluoresces to produce secondary X-rays having a component that propagates in a second or negative direction opposite from the first direction. A measuring chamber is positioned to be responsive to negatively directed X-ray radiation. The measuring chamber includes an ionisable gas which is ionised in response to the X-ray radiation reaching it. An electrode derives a signal current having a magnitude proportional to the amount of ionisation of the gas in the measuring chamber.

Thickness gauges typically comprise a measurement head, a radiation source, a measurement portion arranged to receive a material to be measured, and a radiation detector. The apparatus is arranged such that radiation is incident upon the radiation detector after interaction with the material to be measured in the measurement portion. The interaction may be one or more of absorption, transmission, and scattering. The measurement relies upon determining the strength of the radiation after the interaction, as detected by the radiation detector.

However, radiation sources do not necessarily output a stable signal strength. For example, variation in the strength of the radiation from the radiation source may be due to a variety of factors, including but not limited to one or more of: transients or spikes within an X-ray tube or high voltage generator; high voltage generator ripple; electromagnetic interference; tube degradation in the case of X-ray tubes; and thermal drift. The timescale of such variations may be short (with a period of, for example, less than 10 seconds) or may be long (with a period of, for example, more than 10 seconds). Short timescale variations may alternatively be referred to herein as noise, instabilities, or ripple. Long timescale variations may alternatively be referred to herein as drift or hardware drift.

Thus, variation in the detected signal may be due to variation in the material to be measured or may be due to variation in the strength of the incident radiation from the radiation source. There is accordingly need for an apparatus and method for compensating or otherwise accounting for the variation in the strength of the radiation emission in a radiometric gauge.

### SUMMARY

Systems, methods, and products to address these and other needs are described herein with respect to illustrative, non-limiting, implementations. Various alternatives, modifications and equivalents are possible.

A first aspect of the invention provides a measurement head comprising a radiation source, configured to emit a first radiation beam and a second radiation beam; a segmented chamber; a first radiation detector positioned in a first segment of the segmented chamber and configured to generate a first voltage signal responsive to the first radiation beam; and a second radiation detector positioned in a second segment of the segmented chamber and configured to generate a second voltage signal responsive to material specific radiation produced from an interaction with the second radiation beam.

The radiation may be X-ray radiation. The radiation may be gamma ray radiation. The radiation may be beta radiation.

Radiation shielding may be arranged on a bottom surface of the first segment. The radiation shielding attenuates the material specific radiation.

The material specific may comprise reflected radiation. The material specific may comprise fluorescent radiation. The material specific may comprise or phosphorescent radiation.

The first and second segmented chambers may be concentrically arranged around the radiation source.

The measurement head may also include a shutter configured to attenuate the first radiation beam when in a closed position.

A second aspect of the invention provides gauge that comprises the measurement head and a measurement portion, arranged to receive the material, such that the material is in the path of the second radiation beam that interacts with the material to produce the material specific radiation.

A third aspect of the invention provides a method for compensating for variation produced by a radiation source. The method comprises sampling a first voltage signal from a first radiation detector at a time t; sampling a second voltage signal from a second radiation detector at the time t; normalising the sample of the first and second voltage signals; storing the normalised sample of the first voltage signal taken at time t; determining a compensation factor; and determining a compensated second voltage signal by multiplying the sample of the second voltage signal taken at time t by the compensation factor.

Normalising the sample of the second voltage signal may comprise: closing a shutter to block a radiation beam from the radiation source to prevent the radiation beam from impinging on the first radiation detector; and measuring the voltage signal from the second radiation detector whilst the shutter is closed.

Normalising a sample of a voltage signal from a radiation detector may comprise: closing the radiation source to prevent radiation impinging on the radiation detector; and measuring the voltage signal from the radiation detector whilst the radiation source is closed.

The measured voltage signal from the radiation detector whilst the radiation source is closed may be obtained at any time and may be re-used to normalise multiple subsequent voltage signals.

Variation may be short-timescale variation, also known as fast variation, noise, or ripple. Variation may be long-timescale variation, also known as slow variation or drift. Variation may be any combination of noise and drift.

The first voltage signal, second voltage signal, first radiation detector, and second radiation detector are according to the measurement head provided by the first aspect.

The compensation factor may be determined using one or more of the normalised sample of the second voltage signal taken at the time t; the normalised sample of the first voltage signal taken at the time t; previously stored samples of the first voltage signal taken at times earlier than the time t; and a normalised, standardised first voltage signal.

The normalised, standardised first voltage signal may be the normalised sample of the first voltage signal taken at time t=0. The normalised, standardised first voltage signal may be the initial or first normalised sample of the first voltage signal. The normalised, standardised first voltage signal may be a subsequent normalised sample of the first voltage signal which is defined or considered to be the sample taken at time t=0.

Determining the compensation factor may comprise determining a moving average of the previously stored samples of the first voltage signal taken at times earlier than the time t.

Determining the compensation factor may comprise taking a weighted mean of the moving average and the normalised, standardised first voltage signal. Determining the compensation factor may comprise dividing the weighted mean by the normalised sample of the first voltage signal taken at the time t.

Determining the compensation factor may comprise determining a fast variation compensation factor and a slow variation compensation factor. Determining the compensation factor may comprise multiplying the fast and slow variation compensation factors.

Determining the fast variation compensation factor may comprise determining a moving average of the previously stored samples of the first voltage signal taken at times easier than the time t. Determining the fast variation compensation factor may comprise dividing the moving average by the normalised sample of the first voltage signal taken at the time t.

Determining the slow variation compensation factor may comprise determining a moving average of the previously stored samples of the first voltage signal taken at times earlier than the time t. Determining the slow variation compensation factor may comprise determining a ratio by dividing the normalised, standardised first voltage signal by the moving average. Determining the slow variation compensation factor may comprise multiplying the ratio by a weight, adding unity, and diving by unity plus the weight.

Determining a moving average may comprise determining any averaging filter function. For example, it may comprise determining the mean of the values in a given window. Alternatively, it may comprise exponential filtering. Alternatively, it may comprise Gaussian filtering. Alternatively, it may comprise filtering or determination of a weighted mean of the values in a given window according to any suitable distribution of weights.

A fourth aspect of the invention provides a non-transitory computer-readable medium having stored thereon instructions that, when executed by a processor, cause the processor to perform the method.

A fifth aspect of the invention provides a gauge that comprises a measurement head that includes a radiation source, configured to emit a first radiation beam and a second radiation beam; and a first radiation detector positioned adjacent to the radiation source and configured to generate a first voltage signal responsive to the first radiation beam. The gauge also includes a measurement portion, arranged to receive the material, such that the material is in the path of the second radiation beam that interacts with the material to produce a material specific radiation; and a second radiation detector configured to generate a second voltage signal responsive to the material specific radiation, wherein the measurement portion is positioned between the radiation source and the second radiation detector.

The radiation may be X-ray radiation. The radiation may be gamma ray radiation. The radiation may be beta radiation.

The material specific radiation comprises transmitted radiation.

The measurement head may also include a shutter configured to attenuate the first radiation beam when in a closed position.

### BRIEF DESCRIPTION OF THE DRAWINGS

The disclosure may be put into practice in a number of ways and preferred embodiments will now be described by way of example only and with reference to the accompanying drawings, in which:

FIG. 1 shows a cross-sectional schematic of a gauge with a measurement head according to the disclosure.

FIG. 2 shows a cross-sectional schematic of the measurement head of FIG. 1 with a radiation source according to the disclosure.

FIG. 3 shows a bottom plan schematic of the measurement head of FIGS. 1 and 2 with a segmented chamber according to the disclosure.

FIG. 4 shows a cross-sectional view of an exemplary shutter for the radiation source of FIG. 2 according to the disclosure.

FIG. 5 shows another view of the exemplary shutter for the radiation source of FIG. 4 according to the disclosure.

FIG. 6 shows a cross-sectional schematic of a gauge with measurement head and a detector configured to measure transmitted radiation according to the disclosure.

FIG. 7 shows a method for compensating noise and drift in a radiometric measurement head according to the disclosure.

### DETAILED DESCRIPTION

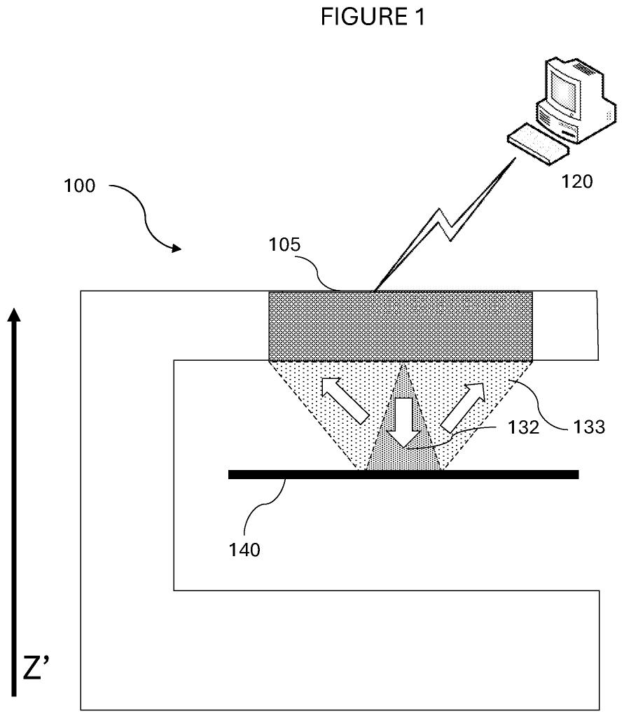

FIG. 1 provides an illustrative example of a gauge 100 that includes a measurement head 105 configured to measure radiation 133 (e.g. backscattered, fluorescent, or phosphorescent radiation) from a material 140 in response to radiation beam 132 according to the disclosure. Material 140 may include any material known in the art typically subjected to gauging applications for measurements of basis weight, thickness, elemental and/or molecular composition and/or distribution, etc. For example, material 140 may include a sheet or web of a metal, elastomer, organic, or plastic, or other material known in the art. Further material 140 may include coated substrates where the measurements may distinguish between substrate and coating characteristics.

FIG. 1 also illustrates a network connection between computer 120 and gauge 100 and/or measurement head 105, however it will be appreciated that FIG. 1 is intended to be exemplary and additional or fewer network connections may be included. Further, the network connection between the elements may include “direct” wired or wireless data transmission (e.g. as represented by the lightning bolt) as well as “indirect” communication via other devices (e.g. switches, routers, controllers, computers, etc.) and therefore the example of FIG. 1 should not be considered as limiting.

Computer 120 may include any type of computing platform such as a workstation, a personal computer, a tablet, a “smart phone”, one or more servers, compute cluster (local or remote), or any other present or future computer or cluster of computers. Computers typically include known components such as one or more processors, an operating system, system memory, memory storage devices (e.g. sometimes referred to as a non-transitory computer-readable medium), input-output controllers, input-output devices, and display devices. It will also be appreciated that more than one implementation of computer 120 may be used to carry out various operations in different embodiments, and thus the representation of computer 120 in FIG. 1 should not be considered as limiting.

In some embodiments, computer 120 may employ a computer program product comprising a computer usable medium having control logic (e.g. computer software program, including program code) stored therein. The control logic, when executed by a processor, causes the processor to perform some or all of the functions described herein. In other embodiments, some functions are implemented primarily in hardware using, for example, a hardware state machine. Implementation of the hardware state machine so as to perform the functions described herein will be apparent to those skilled in the relevant arts. Also in the same or other embodiments, computer 120 may employ an internet client that may include specialized software applications enabled to access remote information via a network. A network may include one or more of the many types of networks well known to those of ordinary skill in the art. For example, a network may include a local or wide area network that may employ what is commonly referred to as a TCP/IP protocol suite to communicate. A network may include a worldwide system of interconnected computer networks that is commonly referred to as the internet, or could also include various intranet architectures. Those of ordinary skill in the related art will also appreciate that some users in networked environments may prefer to employ what are generally referred to as “firewalls” (also sometimes referred to as Packet Filters, or Border Protection Devices) to control information traffic to and from hardware and/or software systems. For example, firewalls may comprise hardware or software elements or some combination thereof and are typically designed to enforce security policies put in place by users, such as for instance network administrators, etc.

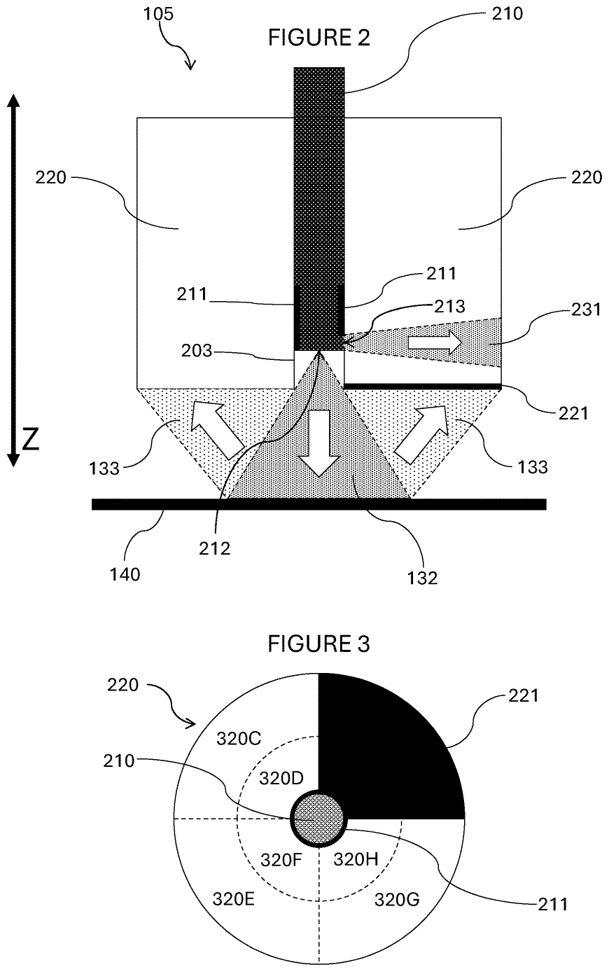

FIG. 2 provides an illustrative example of the measurement head 105 that comprises a radiation source 210. The radiation source 210 emits radiation. The radiation source 210 may generate X-ray radiation, gamma radiation, beta radiation, or any other suitable radiation as may be envisaged by the skilled person and as known in the art. For example, radiation source 210 may include an x-ray tube or HV-generator that may produce spikes, arcs, high voltage ripple, or other transients.

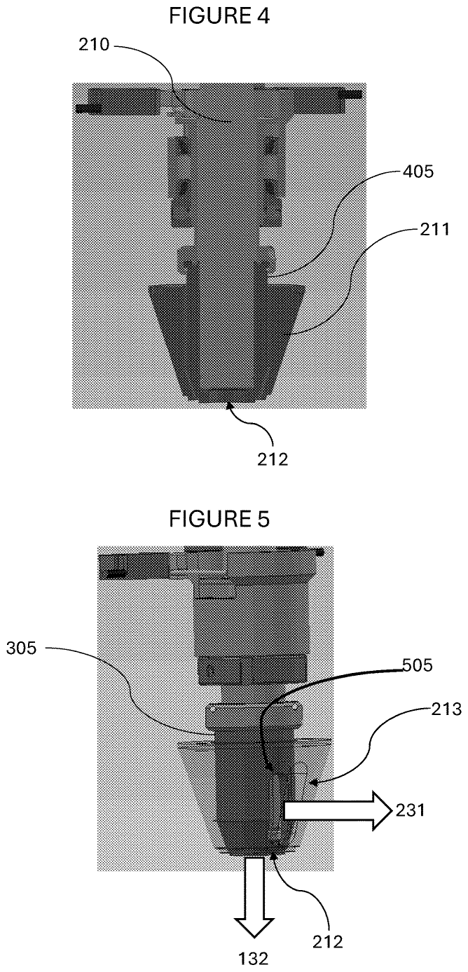

The radiation source 210 further comprises a shutter 211, shown in more detail in FIGS. 4 and 5. Some implementations of measurement head 105 may also include an additional shutter (not shown), typically employed for safety reasons, the shutter positioned to block radiation beam 132 from exiting measurement head 105 (e.g. positioned between radiation source 210 and an exit aperture of measurement head 105). The radiation source 210 may be substantially cylindrical in diameter or other shape that corresponds to the dimensions of an internal channel of measurement head 105. The shutter 211 may be substantially toroidal, enclosing the end portion of radiation source 210. The shutter 211 may comprise material which absorbs the radiation produced by radiation source 210. For example, the shutter 111 may comprise lead, tungsten (alloy), or copper/steel (e.g. in case of lower energies, or carbon hydrogenes (e.g. in case of Beta rays).

The shutter 211 further comprises at least two apertures: a primary aperture 212 and a reference aperture 213, each configured to transmit the radiation produced by radiation source 210. The apertures comprise openings that may in some applications include windows made of a material transparent to the radiation produced by radiation source 210. Reference radiation beam 231 from the radiation produced by radiation source 210 is formed by reference aperture 213. Primary radiation beam 132 from the radiation produced by radiation source 210 is formed by primary aperture 212.

In a typical application, the measurement head 105 is integrated into a gauge system 100 that comprises a measurement portion configured to accept a material 140. The measurement head 105 in the gauge system 100 is arranged such that the radiation of the primary radiation beam 132 impinges upon the material 140 when it is in the measurement portion. In some applications the path of primary radiation beam 132 is substantially parallel to a first axis Z. After impinging on the material 140, the radiation of primary radiation beam 132 interacts with material 140 generating material radiation 133. In the example of FIG. 2, material radiation 133 is representative of the elemental and/or molecular composition of material 140 and may comprise backscattered, fluorescent, phosphorescent radiation, or radiation transmitted through material 140 (e.g. reflected from a substrate underneath material 140 back towards measurement head 105). The radiation of material radiation 133 may accordingly be of the same type or frequency as primary radiation beam 132, or may be of a different type or frequency, or may be of a combination of types or frequencies. The path of material radiation 133 is substantially antiparallel to primary radiation beam 132 along first axis Z (e.g. a path from material 140 to measurement head 105).

As illustrated in FIG. 2, the measurement head 105 comprises a segmented detection chamber 220. The segmented detection chamber 220 may be a segmented ion chamber. The segmented detection chamber 220 has a channel 203 through its length along first axis Z, which may be substantially cylindrical or other geometry known in the related art. In this embodiment the segmented detection chamber 220 is substantially toroidal but other suitable shapes are contemplated herein. The segmented detection chamber 220 has a bottom surface substantially normal to the first axis Z and facing the measurement portion with material 140. The channel 203 of the segmented detection chamber 220 has an inner surface and the radiation source 210 is positioned within the channel 203.

FIG. 3 shows a plan view of the bottom surface of the segmented detection chamber 220. As shown in FIGS. 2 and 3, the segmented detection chamber 320 further comprises a radiation shield 221. The radiation shield 221 may be attached to the bottom surface and or wall surfaces of one or more individual segments of the segmented detection chamber 220. The radiation shield 221 may be constructed of shielding material as described above with regard to shutter 211 (e.g. lead, tungsten (alloy), or copper/steel (e.g. in case of lower energies, or carbon hydrogenes (e.g. in case of Beta rays)). Although FIG. 3 shows the radiation shield 221 covering a quarter of the surface area of the bottom surface of the segmented detection chamber 220 (also illustrated in FIG. 2), other proportions are contemplated herein. The radiation shield 221 may cover any suitable number of individual segments to cover a desired area of the bottom surface of the detection chamber 220. However, an area of the bottom surface of the detection chamber 220 remains uncovered by the radiation shield 221 to allow material radiation 133 to transmit past the bottom surface and into one or more of the individual segments. Factors to be considered by the skilled person when determining what portion of the bottom surface of the detection chamber 220 should be covered by the radiation shield 221 are detailed herein below.

The measurement head 105 is arranged such that the material radiation 133 impinges upon the bottom surface of the segmented detection chamber 220 and the reference radiation beam 231 impinges upon the inner surface of one or more individual segments of the segmented detection chamber 220 (e.g. chamber segments 320A and 320B). The radiation which impinges upon the individual segments of the segmented detection chamber 120 is measured by detectors within the individual segments that generate a voltage, the magnitude of which is related to the intensity of the radiation. As shown in the example of FIG. 3, the segmented detection chamber 120 is subdivided into individual chamber segments 320A, . . . , 320H that may be separated by walls forming distinct chambers. Although eight chamber segments are depicted, it is contemplated herein that there may be two, three, four, or any higher number of chamber segments each having a radiation detector, but not less than two. Each radiation detector may produce a separate measurement voltage, Vⱼ(t) where j is A for chamber segment 320A, B for radiation detector in chamber segment 320B, and so on, related to the intensity of radiation incident upon that radiation detector.

The edges of the radiation shield 121 may be aligned with boundaries between chamber segments, as shown in FIG. 3. Thus, radiation from material radiation beam 133 is heavily attenuated for certain chamber segments, for example chamber segments 320A and 320B. Reference aperture 213 may be arranged to direct reference beam 231 towards the chamber segments 320A, 320B. These may thus be referred to as reference chamber segments. The measurement voltages of the reference detectors, for example, V_{A}(t) and V_{B}(t) or, more generally, Vᵣ(t), may be referred to as reference voltages. The measurement voltages of the non-reference detectors (also referred to herein as incident detectors), for example, V_{F}(t) and V_{G}(t) or, more generally, Vᵢ(t), may be referred to as incident voltages.

As described above, the radiation source 210 comprises a shutter 211, shown in more detail in FIGS. 4 and 5. The radiation source 210 may be substantially cylindrical and the shutter 211 may be substantially toroidal, substantially enclosing an end cover 405 of radiation source 210. Similar to the shutter 211, the end cover 405 may be constructed of a material which absorbs the radiation (e.g. lead, tungsten, tungsten alloy, copper, or steel). End cover 405 includes primary aperture 212. Shutter 211 may be rotatable around the end cover 405 (e.g. under motor control, manual control, etc.) in order to reversibly change from an “open” state and a “closed” state. When positioned in the open state opening 505 in end cover 405 is aligned to reference aperture 213 of shutter 211 allowing reference beam 231 to travel to a reference detector as described above. When positioned in the closed state opening 505 in end cover 405 is not aligned to reference aperture 213 of shutter 211 blocking reference beam 231 (e.g. also sometimes referred to as a “noise cancelling shutter”).

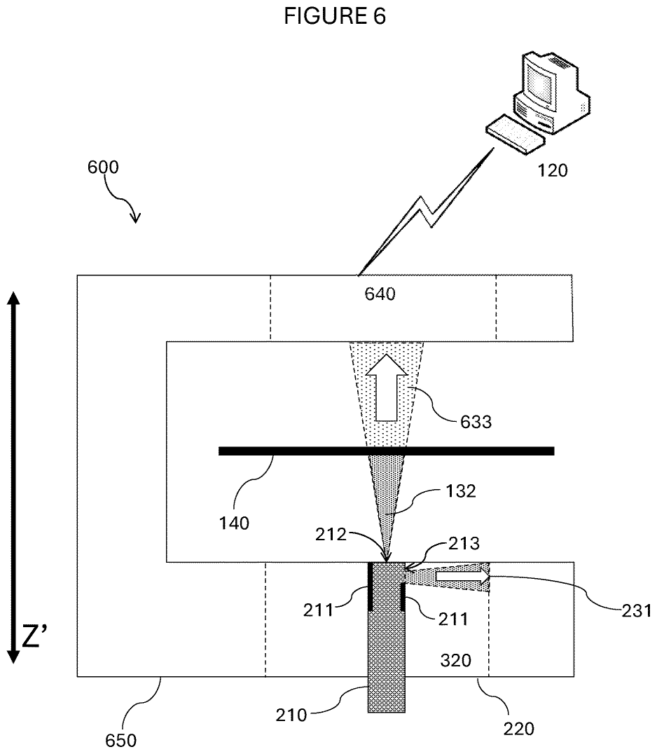

FIG. 6 provides an illustrative example of a transmission gauge 600 according to the disclosure. The transmission gauge 600 comprises a radiation source 210 as described above. For example, the radiation may be X-ray radiation or any other suitable radiation as may be envisaged by the skilled person and as known in the art.

The transmission gauge 600 further comprises a measurement portion configured to accept a material 140. The transmission gauge 600 is arranged such that the radiation of the primary radiation beam 132 impinges upon the material to be measured 140 when it is in the measurement portion. The path of primary radiation beam 132 is substantially parallel to a first axis Z′. After impinging on the material 140 the primary radiation beam 132 interacts with material 140 to form transmitted radiation 633 that follows the substantially parallel path along first axis Z′ to detector 640. The detector 640 may include any type of detector known in the art for detecting the type of radiation of transmission beam 633. The radiation which impinges upon the detector 640 causes detector 640 to generate a voltage, the magnitude of which is related to the intensity of the radiation. For example, transmitted radiation 633 represents the degree of absorption of the radiation from primary radiation beam 132 where the degree of absorption is representative of the characteristics of material 140.

The transmission gauge 600 further comprises a segmented detection chamber 220 with radiation source 210, shutter 211, primary aperture 212, and reference aperture 213 as described above. Further, segmented detection chamber 220 is arranged such that the reference radiation beam 231 impinges on a detector of a chamber segment 320, where the detector generates a voltage, the magnitude of which is related to the intensity of the radiation. It will be understood that in the arrangement of transmission gauge 600, radiation source 210, shutter 211, primary aperture 212, and reference aperture 213 do not need to be housed in segmented detection chamber 220, rather each element can be positionally configured to operate as independent elements. For example, the reference radiation detector may be positioned adjacent to radiation source 210 (e.g. as well as shutter 211 and reference aperture 213) and configured to generate a voltage signal responsive to reference radiation beam 231.

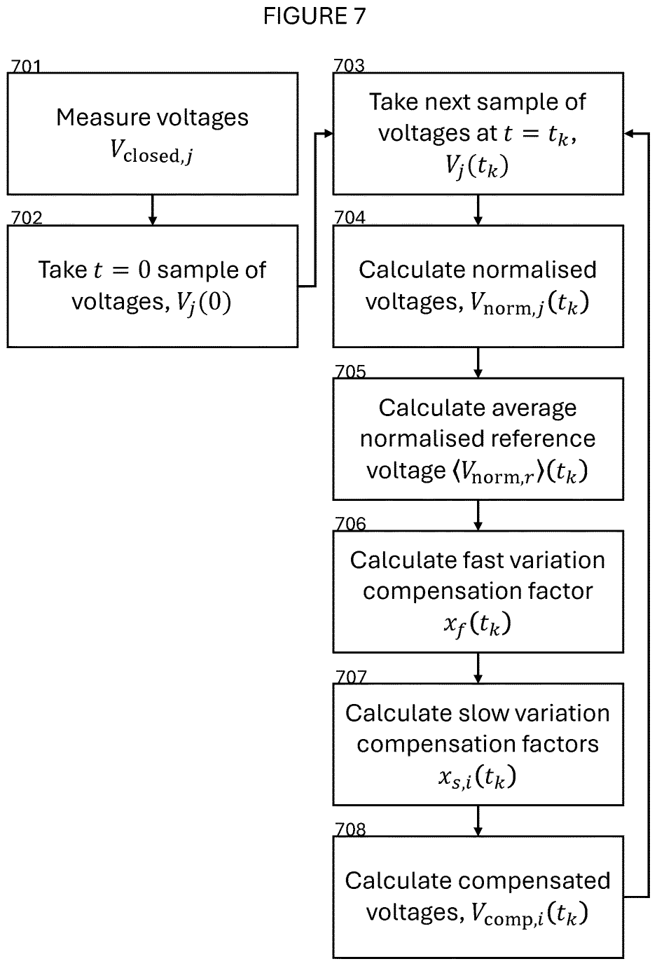

The method 700 of FIG. 7 may be used to compensate noise and drift in any apparatus according to this disclosure.

At step 701, the background measurement voltages, V_{closed,j}, of each radiation detector in a chamber segment 320A, . . . , 320H are determined. The background measurement voltages V_{closed,j} are the measurement voltages measured when the radiation from radiation source 210 is closed, switched off, or otherwise not emitting radiation into the segmented detection chamber 220 by any means known in the art. For example, shutter 211 may be in a closed state as described above, blocking reference radiation beam.

At step 702, an initial sample, Vⱼ(0), of each measurement voltage is taken. The time of the initial sample is defined to be t=t₀=0 for the purposes of method 700. The sample number k for the initial sample is zero. That is, k=0 for the initial sample.

At step 703, a next sample, Vⱼ(tₖ), of each measurement voltage is taken at time t=tₖ, where k is one greater than the sample number of the previous sample, tₖ>0, and tₖ>tₖ₋₁.

At step 704, normalised measurement voltages for sample k, V_{norm,j}(tₖ), are calculated as the measurement voltages of sample k less the background measurement voltages. That is, V_{norm,j}(tₖ)=Vⱼ(tₖ)−V_{closed,j}. Calculating the normalised measurement voltages may further comprise multiplying by a scaling factor aⱼₖ, for example, V_{norm,j}(tₖ)=aⱼₖVⱼ(tₖ)−V_{closed,j}. The scaling factor may account for one or more characteristics that affect the measured voltage (e.g. detector drift, aging of radiation source 210, contamination of components, etc.).

At step 705, an average normalised reference voltage for sample k is calculated as the moving average of the previous N samples of the normalised reference voltage,

$$( {V}_{n o r m , r} 〉 ( {t}_{k} ) = \frac{1}{N} {\sum }_{p = k - N}^{k - 1} {V}_{n o r m , r} ( {t}_{p} ) .$$

more than one reference voltage, multiple average normalised reference voltages may be calculated. If multiple average normalised reference voltages are calculated, they may be combined or averaged by any means known in the art. Additionally or alternatively, the normalised reference voltages of each reference detector may be combined or averaged by any means known in the art and a single average normalised reference voltage may be calculated from the combined or averaged normalised reference voltages.

At step 706, a short-term or fast variation compensation factor is calculated for sample k as a function of at least the average normalised reference voltage for sample k and the normalised reference voltage for sample k. The function may be a simple ratio or any other analytical formula x_{f}(tₖ); for example,

$${x}_{f} ( {t}_{k} ) = \frac{〈 {V}_{n orm , r} 〉 ( {t}_{k} )}{{V}_{n orm , r} ( {t}_{k} )} .$$

That is, the short-term or fast variation compensation factor for sample k is the ratio of the average normalised reference voltage for sample k to the normalised reference voltage for sample k. The function may be any other suitable function known in the art to the skilled person.

At step 707, long-term or slow variation compensation factors for sample k are calculated for each incident detector a function of at least the average normalised reference voltage for sample k and the normalised reference voltage at t=0. For example, the function may be any analytical formula x_{s,i}(tₖ), such as

$${x}_{s , i} ( {t}_{k} ) = \frac{1 + {a}_{i} \frac{{V}_{nom , r} ( 0 )}{〈 {V}_{norm , r} 〉 ( {t}_{k} )}}{1 + {a}_{i}} ,$$

where aᵢ is a weighting factor which may be arbitrarily varied according to the specific measurement being carried out (aᵢ can be negative).

At step 708, compensated measurement voltages for sample k are calculated for each incident detector as V_{comp,i}(tₖ)=x_{f}(tₖ)x_{s,i}(tₖ)V_{norm,i}(tₖ). That is, as the product of the fast variation compensation factor for sample k, the slow variation compensation factor for sample k and for that incident detector, and the normalised incident voltage for sample k and for that incident detector.

The method 700 then returns to step 703 and loops until terminated.

The time between one sample and the subsequent sample, tₖ−tₖ₋₁, is the sampling period. The sampling frequency is the inverse of the sampling period. That is, the sampling frequency is one over the sampling period. Any suitable sampling frequency known in the art or envisaged by the skilled person may be selected.

It is contemplated herein that steps 704 through 708 may also be carried out between step 702 and step 703, in addition to being carried out after every iteration of step 703.

1. A measurement head comprising:
a radiation source, configured to emit a first radiation beam and a second radiation beam;
a segmented chamber;
a first radiation detector positioned in a first segment of the segmented chamber and configured to generate a first voltage signal responsive to the first radiation beam; and
a second radiation detector positioned in a second segment of the segmented chamber and configured to generate a second voltage signal responsive to material specific radiation produced from an interaction with the second radiation beam.

2. The measurement head of claim 1, wherein the first and second radiation beams comprise X-ray radiation, gamma ray radiation, or beta radiation.

3. The measurement head of claim 1, comprising shielding on a bottom surface of the first segment.

4. The measurement head of claim 3, wherein the shielding on a bottom surface of the first segment attenuates the material specific radiation.

5. The measurement head of claim 1, wherein the material specific radiation comprises reflected radiation, fluorescent radiation, or phosphorescent radiation.

6. The measurement head of claim 1, wherein the first and second segmented chambers are concentrically arranged around the radiation source.

7. The measurement head of claim 1, wherein the measurement head further comprises a shutter configured to attenuate the first radiation beam when in a closed position.

8. A gauge comprising:
the measurement head of claim 1; and
a measurement portion, arranged to receive the material, such that the material is in the path of the second radiation beam that interacts with the material to produce the material specific radiation.

9. A method for compensating variation in a measurement head, the method comprising:
sampling a first voltage signal responsive to a first radiation beam from a first radiation detector at a time t;
sampling a second voltage signal responsive to a second radiation beam from a second radiation detector at the time t;
normalizing the samples of the first and second voltage signals;
storing the normalized sample of the first voltage signal taken at the time t;
determining a compensation factor; and
determining a compensated second voltage signal by multiplying the sample of the second voltage signal taken at the time t by the compensation factor.

10. The method of claim 9, wherein the compensation factor is determined using one or more of:
the normalized sample of the second voltage signal taken at the time t;
the normalized sample of the first voltage signal taken at the time t;
previously stored samples of the first voltage signal taken at times earlier than t; and
a normalised, standardized first voltage signal.

11. The method of claim 9, wherein determining the compensation factor comprises determining a moving average of the previously stored samples of the first voltage signal taken at times earlier than t.

12. The method of claim 11, wherein determining the compensation factor comprises:
taking a weighted mean of the moving average and the normalized, standardised first voltage signal; and optionally
dividing the weighted mean by the normalized sample of the first voltage signal taken at the time t.

13. The method of claim 9 wherein determining the compensation factor comprises:
determining a fast variation compensation factor and a slow variation compensation factor,
wherein the compensation factor is determined by multiplying the fast and slow variation compensation factors.

14. The method of claim 13, wherein determining the fast variation compensation factor comprises:
determining a moving average of the previously stored samples of the first voltage signal taken at times earlier than t; and
dividing the moving average by the normalized sample of the first voltage signal taken at the time t.

15. The method of claim 13, wherein determining the slow variation compensation factor comprises:
determining a moving average of the previously stored samples of the first voltage signal taken at times earlier than t;
determining a ratio by dividing the normalized, standardized first voltage signal by the moving average; and
multiplying the ratio by a weight, adding unity, and dividing by unity plus the weight.

16. A non-transitory computer-readable medium having stored thereon instructions that, when executed by a processor, cause the processor to perform a method comprising:
sampling a first voltage signal responsive to a first radiation beam from a first radiation detector at a time t;
sampling a second voltage signal responsive to a second radiation beam from a second radiation detector at the time t;
normalizing the samples of the first and second voltage signal;
storing the normalized sample of the first voltage signal taken at the time t;
determining a compensation factor; and
determining a compensated second voltage signal by multiplying the sample of the second voltage signal taken at the time t by the compensation factor.

17. A gauge comprising:
a measurement head comprising:
a radiation source, configured to emit a first radiation beam and a second radiation beam; and
a first radiation detector positioned adjacent to the radiation source and configured to generate a first voltage signal responsive to the first radiation beam;
a measurement portion, arranged to receive the material, such that the material is in the path of the second radiation beam that interacts with the material to produce a material specific radiation; and
a second radiation detector configured to generate a second voltage signal responsive to the material specific radiation, wherein the measurement portion is positioned between the radiation source and the second radiation detector.

18. The gauge of claim 17, wherein the first and second radiation beams comprise X-ray radiation, gamma ray radiation, or beta radiation.

19. The gauge of claim 17, wherein the material specific radiation comprises transmitted radiation.

20. The gauge of claim 17, wherein the measurement head further comprises a shutter configured to attenuate the first radiation beam when in a closed position.
